(19) United States
(12) Patent Application Publication
(10) Pub. No.: US 2007/0121971 A1
(43) Pub. Date: May 31, 2007

(54) AUDIO MIXING DEVICE AND AUDIO MIXING METHOD

(76) Inventor: Takanobu Mukaide, Tachikawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/532,364

(22) Filed: Sep. 15, 2006

(30) Foreign Application Priority Data
Nov. 30, 2005 (JP) 2005-347113

(51) Int. Cl. H04B 1/00; H04B 1/20

(52) U.S. Cl. 381/119; 369/4

(57) ABSTRACT

According to one embodiment, an audio mixing device comprising an input part in which a plurality of audio data is input, a conversion part which converts the sampling frequency of all input audio data, a control part which controls such that the sampling frequency of the input audio data is converted into the preset reference sampling frequency for each conversion part, and a mixing part which mixes all audio data output from the conversion part by converting the sampling frequency into the reference sampling frequency, is provided.

### CROSS-REFERENCE TO RELATED APPLICATIONS

This application is based upon and claims the benefit of priority from Japanese Patent Application No. 2005-347113, filed Nov. 30, 2005, the entire contents of which are incorporated herein by reference.

### BACKGROUND

1. Field

One embodiment of the present invention relates to an audio mixing device used, for example, with an optical disk device, and improvement of an audio mixing method.

2. Description of the Related Art

As is well known, optical disks such as Digital Versatile Discs (DVDs) have been widespread as a digital recording medium in recent years. In addition, high reliability is required for an optical disk device reproducing this kind of optical disk.

Further, the DVD standard itself has been developed, and currently, the next generation DVD standard supporting high vision that is referred to as High Definition (HD) DVD or Blu-ray disk has been completed. Since the recording density of the next generation DVD standard is significantly increased over that of the current generation DVD, optical disk devices are also required to enhance their functions.

For example, an optical disk device supporting the next generation DVD standard may output a plurality of audio data, while mixing it, which is obtained from an optical disk, a network server, etc. However, the sampling frequency of all audio data needs to be matched for mixing of a plurality of audio data.

Thus, currently, the mixing is performed by matching a sampling frequency to the highest sampling frequency among a plurality of audio data, or by matching the sampling frequency of other audio data to one of the sampling frequencies of audio data selected based on the previously specified method.

However, in the above-mentioned means, when the sampling frequency of the audio data is to be matched with the sampling frequency, all of the sampling frequencies of the audio data to be mixed need to change their sampling frequency of audio data accordingly, during which time, audio output must be stopped.

Jpn. Pat. Appln. KOKAI Publication No. 2-277308 discloses that mixing is performed by converting a plurality of digital signals having different sampling frequencies into a digital signal having the same sampling frequency as a double oversampling digital filter; however, no concrete control method is described, and thus it is not suitable for practical use.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one embodiment of the present invention, which is illustrated for explaining an optical disk device.

FIG. 2 is a diagram shown to explain a pickup used for an optical disk device in the same embodiment.

FIG. 3 is a block diagram shown to explain a specific example of an audio mixing part of an optical disk device in the same embodiment.

FIG. 4 is a flowchart shown to explain an audio mixing operation of an optical disk device in the same embodiment.

FIG. 5 is a diagram shown to explain the effects of an audio mixing operation for an optical disk device in the same embodiment.

### DETAILED DESCRIPTION

Various embodiments according to the invention will be described hereinafter with reference to the accompanying drawings. In general, according to one embodiment of the invention, an audio mixing device comprising: an input part in which a plurality of audio data is input; a conversion part which converts the sampling frequency of all input audio data; a control part which controls such that the sampling frequency of the input audio data is converted into the preset reference sampling frequency for each conversion part; and a mixing part which mixes all audio data output from the conversion part by converting the sampling frequency into the reference sampling frequency; is provided.

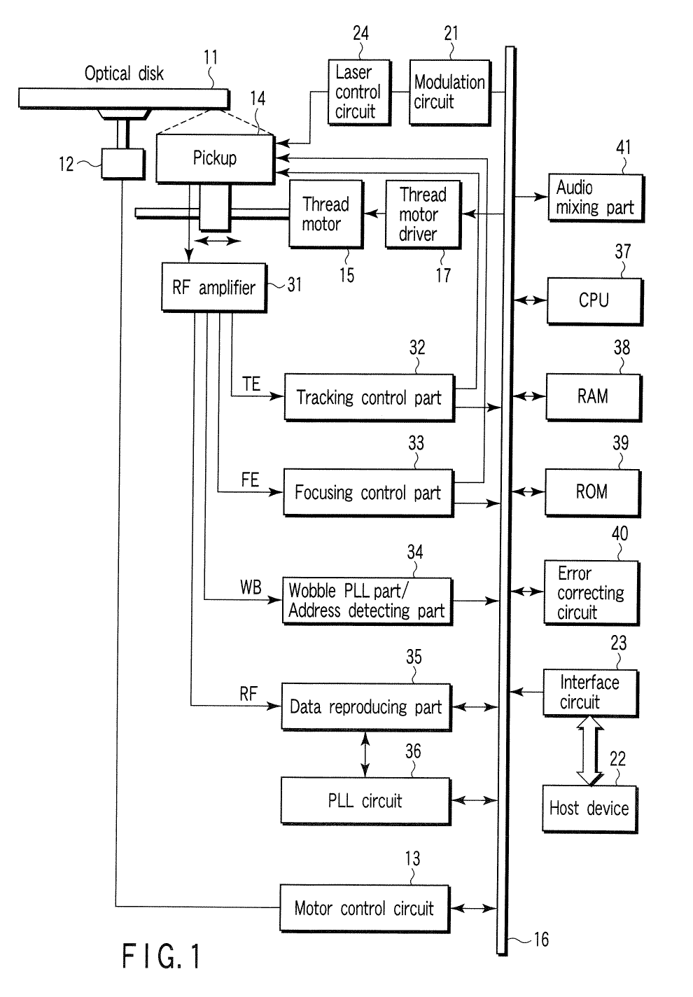

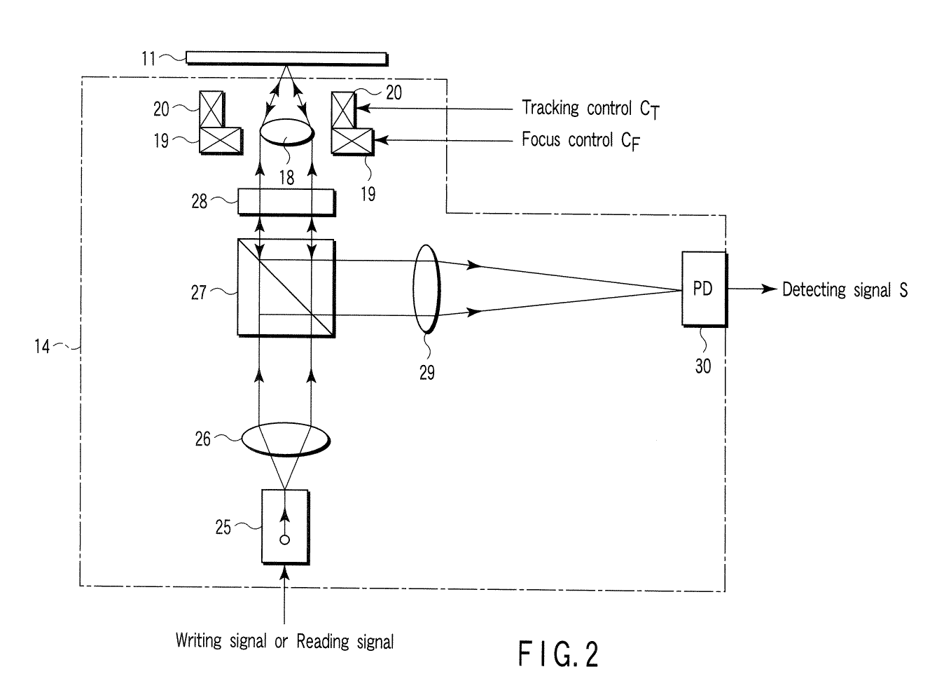

The optical disk device associated with this embodiment has a configuration as shown in FIG. 1 and FIG. 2. Regarding an optical disk 11, although a user data recordable (or rewritable) optical disc or a read-only optical disk is targeted, in this example, it is explained as an optical disk including a recordable (or rewritable) next generation DVD.

The recordable or rewritable optical disk 11 includes, for example, a next generation DVD-RAM (Random Access Memory) using a blue laser beam with a wavelength of around 405 nm, DVD-RW (Rewritable), DVD-R (Recordable), etc., or current DVD-RAM, DVD-RW, DVD-R, etc. using a red laser beam with a wavelength of around 650 nm.

A land track and a groove track are spirally formed on the surface of the optical disk 11. This optical disk 11 is rotating-driven by a spindle motor 12. The rotating speed of this spindle motor 12 is controlled by a motor control circuit 13.

Recording and reproducing of information for the optical disk 11 are performed with a pickup 14. The pickup 14 is connected to a thread motor 15 through a gear. This thread motor 15 is controlled by a thread motor driver 17 connected to a data bus 16. A permanent magnet (not shown) is provided in the fixed portion of the thread motor 15. The pickup 14 is moved in the radial direction of the optical disk 11 by exciting a drive coil (not shown).

An object lens 18 is provided in the pickup 14 as shown in FIG. 2. The object lens 18 is movable in the focusing direction (optical axis direction of the lens) by driving with a drive coil 19, and is also movable in the tracking direction (orthogonal direction to the optical axis of the lens) by driving a drive coil 20, which can be track-jumped by moving the beam spot of a laser beam.

A modulation circuit 21 performs, for example, 8-14 modulation (Eight to Fourteen Modulation: FEM) for user data supplied from a host device 22 through an interface circuit 23 at information recording to generate EFM data. A laser control circuit 24 provides a writing signal to a semiconductor laser diode 25 based on EFM data supplied from the modulation circuit 21 at information recording (at mark forming).

In addition, the laser control circuit 24 provides the semiconductor laser diode 25 with a reading signal that is smaller than a writing signal at information reading.

The semiconductor laser diode 25 generates a laser beam in response to a writing signal supplied from laser control circuit 24. The laser beam emitted from the semiconductor diode 25 is irradiated on the optical disk 11 through a collimating lens 26, a half prism 27, an optical system 28, and the object lens 18. Reflected light from the optical disk 11 is led to a photodetector 30 through the object lens 18, the optical system 28, the half prism 27, and a condensing lens 29.

The photodetector 30 comprises a photodetection cell divided in four, and supplies signals A, B, C, and D to a Radio Frequency (RF) amplifier 31. The RF amplifier 31 supplies, for example, a tracking error signal TE corresponding to (A+D)−(B+C) to a tracking control part 32 by employing a push-pull method, and supplies, for example, a focus error signal FE corresponding to (A+C)−(B+D) to a focusing control part 33 by employing an astigmatism method.

Further, the RF amplifier 31 supplies, for example, a wobble signal WB corresponding to the (A+D)−(B+C) to a wobble PLL part/address detecting part 34, and supplies a RF signal corresponding to (A+D)+(B+C) to a data reproducing part 35.

The output signal of the focusing control part 33 is supplied to the drive coil 19 of the focusing direction. Thus, the laser beam is controlled so that it is always focused only on the recording film of the optical disk 11. In addition, the tracking control part 32 generates a track driving signal in response to the tracking error signal TE, which is supplied to the drive coil 20 of the tracking direction.

By performing the above-mentioned focusing control and tracking control, the change of reflectivity from a pit, etc. formed on a track of the optical disk 11 in response to recorded information is reflected on a sum signal RF of output signals from the photodetection cell of the photodetector 30. This signal is supplied to a data reproducing part 35.

The data reproducing part 35 reproduces recorded data based on a reproducing clock signal from a PLL circuit 36. In addition, the data reproducing part 35 comprises a function to measure the amplitude of the signal RF, and the measured value is read by a Central Processing Unit (CPU) 37.

The pickup 14 is controlled by the thread motor 15 being controlled so that the object lens 18 is placed at the optimum position of the optical disk 11, when the object lens 18 is controlled by the tracking control part 32.

The motor control circuit 13, the laser control circuit 24, the focusing control part 33, the tracking control part 32, the data reproducing part 35, the PLL circuit 36, etc., can be composed on one LSI chip as a servo control circuit.

In addition, these circuit parts are controlled by the CPU 37 through the bus 16. The CPU 37 controls this optical disk device comprehensively based on an operational command supplied from the host device 22 through the interface circuit 23 or operation information from an operation part (not shown).

Further, the CPU 37 uses a RAM 38 as an operation area, which performs a prescribed operation in accordance with a program recorded on a Read-only Memory (ROM) 39.

Then, data reproduced in the data reproducing part 35 is provided for reproducing an image, a secondary image, and audios after error correction is conducted on the data by an error correcting circuit 40.

Wherein, an audio mixing part 41 is connected to the bus 16. This audio mixing part 41 enables outputting a plurality of digital audio data to the exterior of the optical disk device with the mixing. The plurality of digital audio data includes the digital audio data reproduced from the optical disk 11 and the digital audio data obtained from an external network server through the interface circuit 23.

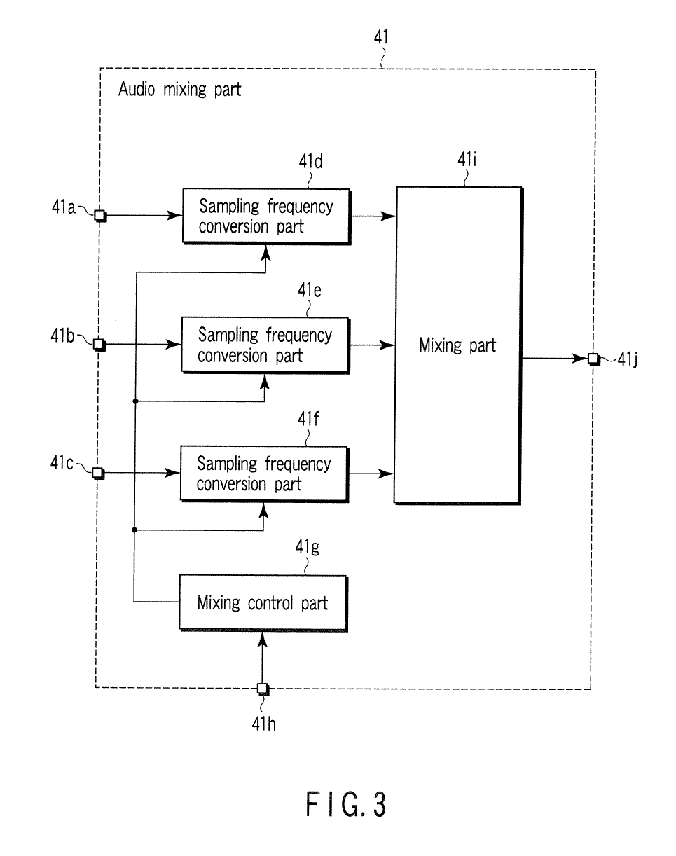

FIG. 3 shows a specific example of the audio mixing part 41. That is, this audio mixing part 41 comprises a plurality of (there are three in the figure) audio input terminals 41a, 41b, and 41c.

In addition, this embodiment is explained assuming that audio data that becomes main audio reproduced from the optical disk 11 is supplied to the audio input terminal 41a, audio data that becomes sub-audio obtained from an external network server is supplied to the audio input terminal 41b, and audio data that becomes effect audio obtained from, for example, an external network server is supplied to the audio input terminal 41c.

In the next generation DVD standard, three kinds of sampling frequencies (48, 96, and 192 kHz) of audio data that becomes main audio are specified, and three kinds of sampling frequencies (12, 24, and 48 kHz) of audio data that becomes sub-audio and effect audio are specified, respectively.

Then, the audio data supplied to the audio input terminal 41a is supplied to a sampling frequency conversion part 41d. This sampling frequency conversion part 41d performs conversion of the sampling frequency for audio data to be input, output stop of audio data during conversion, and so on based on the control of a mixing control part 41g.

Then, the audio data supplied to the audio input terminal 41b is supplied to a sampling frequency conversion part 41e. This sampling frequency conversion part 41e executes conversion of the sampling frequency for audio data to be input, output stop of audio data during conversion, and so on based on the control of a mixing control part 41g.

Then, the audio data supplied to the audio input terminal 41c is supplied to a sampling frequency conversion part 41f. This sampling frequency conversion part 41f executes conversion of sampling frequency for audio data to be input, output stop of audio data during conversion, and so on based on the control of a mixing control part 41g.

Wherein, the mixing control part 41g selectively controls each sampling frequency conversion part 41d, 41e, and 41f based on a control signal from the CPU 38 supplied through a control terminal 41h.

That is, the mixing control part 41g controls sampling frequency conversion so that the sampling frequency of audio data to be input becomes a preset reference sampling frequency (e.g., 96 kHz) for each sampling frequency conversion part 41d, 41e, and 41f.

In this case, when the sampling frequency of audio data to be input is changed for each sampling frequency conversion part 41d, 41e, and 41f, the mixing control part 41g controls so that it converts the changed sampling frequency to the reference sampling frequency; however, it controls to stop the output of audio data during conversion, and to resume outputting audio data after the change to the reference sampling frequency is completed.

Then, all audio data having the reference sampling frequency output from each sampling frequency conversion part 41d, 41e, and 41f is supplied to a mixing part 41i to conduct mixing, and is led externally from an audio output terminal 41j.

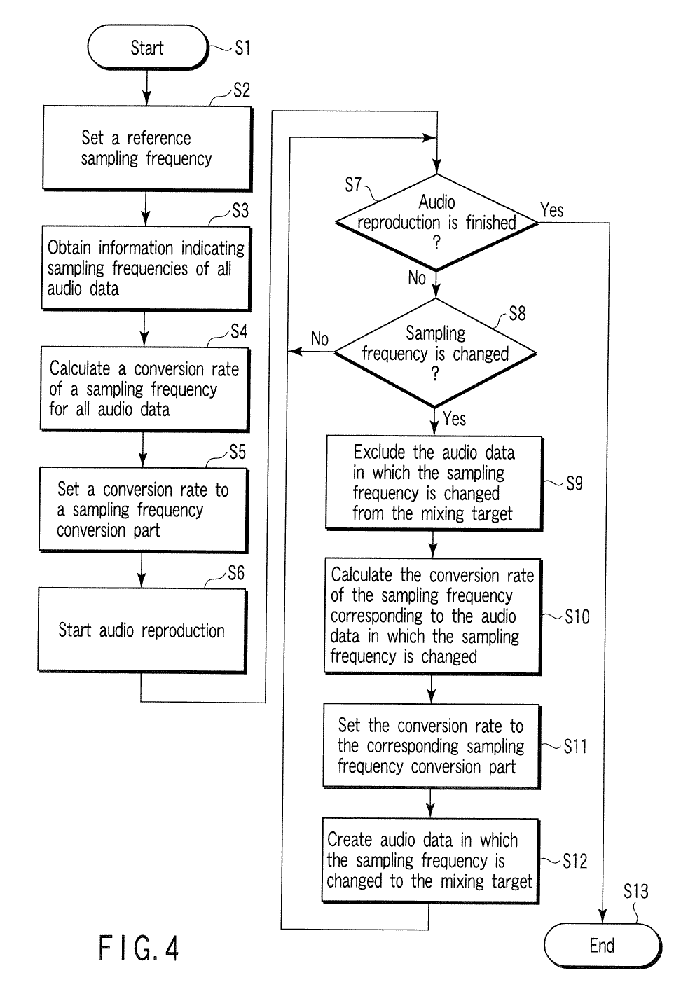

In the above-mentioned configuration, the audio mixing operation will now be explained with reference to the flowchart shown in FIG. 4. That is, when this operation is started (block S1), CPU 37 sets the reference sampling frequency in block S2.

This reference sampling frequency may be preset fixedly, or may be set, if desired, in consideration of the amount of audio data to be processed and the processing capacity of the audio mixing part 41. In addition, it may also be possible that a plurality of reference sampling frequency types are prepared in advance so that a user can select any of the reference sampling frequency types.

Next, in block S3, CPU 37 obtains the sampling frequency of all audio data to be mixed, that is, all audio data supplied to the audio input terminal 41a, 41b, and 41c. This information can be obtained from information of an image and audio obtained from a network server or obtained from management information and information of an image and audio recorded on the optical disk 11.

Then, in block S4, CPU 37 calculates a conversion rate to convert the sampling frequency into the reference sampling frequency for all audio data supplied to the audio input terminals 41a, 41b, and 41c respectively, and supplies it to the mixing control part 41g. When the reference sampling frequency is 96 kHz and the sampling frequency of audio data is 48 kHz, this conversion rate is calculated as 96/48=2.

Then, in block S5, the mixing control part 41g sets the conversion rate for all audio data supplied from CPU 37 to the corresponding sampling frequency conversion parts 41d, 41e, and 41f respectively. Thereby, each sampling frequency conversion part 41d, 41e, and 41f convert the input sampling frequency of the audio data into the reference sampling frequency to output.

In this case, if the conversion rate is 2 as described above, upsampling that doubles the sampling frequency of the audio data is performed. Whereas, if the reference sampling frequency is lower than the sampling frequency of the audio data, since the conversion rate will be zero to one, downsampling that lowers the sampling frequency of the audio data will be performed.

And, when the audio data that is converted into the reference sampling frequency is output from each sampling frequency conversion part 41d, 41e, and 41f, in block S6, the mixing part 41i outputs all audio data with mixing, and thus audio reproduction is started.

Then, in block S7, CPU 37 determines whether the audio reproduction is completed, and when it is determined that it is finished (YES), the audio mixing operation is finished (block S13).

However, in block S7, when it is determined that the audio reproduction is not finished (NO), in block S8, CPU 37 determines whether there is any change in the sampling frequency of all audio data supplied to the audio input terminal 41a, 41b, and 41c. This determination can be performed based on information indicating the sampling frequency of all audio data explained in block S3 previously.

And, in block S8, when it is determined that there is no change in the sampling frequencies of all audio data (NO), CPU 37 returns to the process in block s7.

However, in block S8, when it is determined that there is change in any of the sampling frequencies of all audio data (YES), in block S9, CPU 37 controls the mixing control part 41g so that the audio data in which the sampling frequency is changed is excluded from the mixing target. Thereby, the mixing control part 41g controls so that the sampling frequency conversion part 41d, 41e, or 41f corresponding to the audio data in which the sampling frequency is changed stops the output of audio data.

Next, in block S10, CPU 37 obtains information indicating the sampling frequency, and calculates a conversion rate to convert the sampling frequency into the reference sampling frequency for the audio data in which the sampling frequency is changed, and supplies it to the mixing control part 41g.

Then, in block S11, the mixing control part 41g set the conversion rate supplied from CPU 37 to the corresponding sampling frequency conversion parts 41d, 41e, 41f respectively. Thereby, corresponding sampling frequency conversion parts 41d, 41e, and 41f convert the input sampling frequency of the audio data into the reference sampling frequency to output.

Then, in block S12, CPU 37 controls the mixing control part 41g so that the audio data converted into the reference sampling frequency is a mixing target, and shifts to the process in block S7. Thereby, the mixing control part 41g controls so that it cancels the output stop of the audio data for corresponding sampling frequency conversion part 41d, 41e, or 41f, and thus the audio data is mixed.

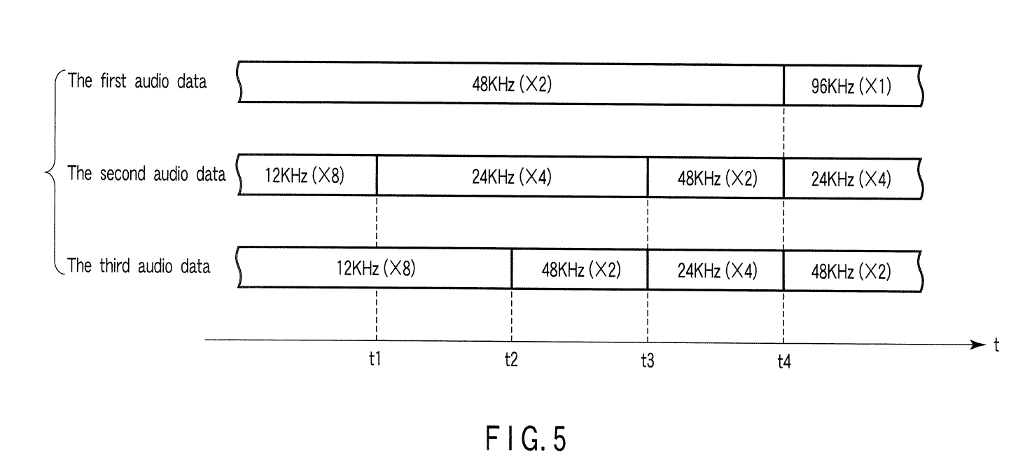

The effects of the above-mentioned audio mixing operation are explained in detail with reference to FIG. 5. In FIG. 5, the audio data which is supplied to the audio input terminal 41a is referred to as the first audio data, the audio data which is supplied to the audio input terminal 41b is referred to as the second audio data, and the audio data which is supplied to the audio input terminal 41c is referred to as the third audio data.

It is assumed that the reference sampling frequency is set to 96 kHz, and before time t1, the sampling frequency of the first audio data is 48 kHz, the sampling frequency of the second audio data is 12 kHz, and the sampling frequency of the third audio data is 12 kHz.

In this case, the first audio data is double upsampled with the sampling frequency conversion part 41d and is converted into the reference sampling frequency. The second audio data is eightfold upsampled with the sampling frequency conversion part 41e and is converted into the reference sampling frequency. The third audio data is eightfold upsampled with the sampling frequency conversion part 41f and is converted into the reference sampling frequency.

In the above-mentioned state, it is assumed that the sampling frequency of the second audio data is changed to 24 kHz at time t1. In this process, the output of the second audio data is stopped by the sampling frequency conversion part 41e, and then it is output after being fourfold upsampled and converted into the reference sampling frequency.

That is, the second audio data is not output during processing to convert the changed sampling frequency into the reference sampling frequency, and meanwhile, the first and third audio data are continuously output. Consequently, the output of the mixed audio data is continued, and thereby, stopping of the audio output can be prevented.

In addition, it is assumed that the sampling frequency of the third audio data is changed to 48 kHz at time t2. In this process, the output of the third audio data is stopped by the sampling frequency conversion part 41f, and then it is output after being double upsampled and converted into the reference sampling frequency.

That is, the third audio data is not output during processing to convert the changed sampling frequency into the reference sampling frequency, and meanwhile, the first and second audio data are continuously output. Consequently, the output of the mixed audio data is continued, and thereby, stopping of the audio output can be prevented.

Further, it is assumed that the sampling frequency of the second audio data is changed to 48 kHz at time t3 and the sampling frequency of the third audio data is simultaneously changed to 24 kHz. In this process, the output of the second audio data is stopped by the sampling frequency conversion part 41e, and then it is output after being double upsampled and converted into the reference sampling frequency. Moreover, the output of the third audio data is stopped by the sampling frequency conversion part 41f, and then it is output after being fourfold upsampled and converted into the reference sampling frequency.

That is, the second and third audio data are not output during processing to convert the changed sampling frequency into the reference sampling frequency, and meanwhile, the first audio data is continuously output. Consequently, the output of the mixed audio data is continued, and thereby, stopping of the audio output can be prevented.

However, as shown at time t4, when the sampling frequencies of the first to the third audio data are simultaneously changed, since the first to the third audio data are not output while they are converted into the reference sampling frequency in the sampling frequency conversion part 41d to 41f, only in this case, the audio output is stopped. However, since it is a rare possibility that the sampling frequencies of the first to the third audio data are simultaneously changed, there is no problem with practical use.

According to the above-mentioned embodiment, since it is intended to match the sampling frequency of the first to the third audio data to be mixed to the preset reference sampling frequency, if any of the sampling frequencies of the audio data are changed, the output of the other audio data is continued, and thus, stopping of the audio output can be prevented as much as possible.

In addition, in the above-mentioned embodiment, although the number of the audio data to be mixed is of three kinds, it is not limited to this, and the present invention can also be applied in the case of mixing of four or more kinds of audio data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An audio mixing device comprising:
a plurality of input parts which are configured such that digitized audio data is input respectively;
a plurality of conversion parts installed corresponding to the plurality of input parts and configured to convert a sampling frequency of audio data input to the input part respectively;
a control part configured to control so that the sampling frequency of the audio data to be input is converted into a preset reference sampling frequency for each of the plurality of conversion parts; and
a mixing part configured to mix, while controlling the control part, all audio data output from the plurality of conversion parts after converting the sampling frequency into the reference sampling frequency.

2. An audio mixing device according to claim 1, wherein the control part detects the audio data in which the sampling frequency is changed and controls so that the sampling frequency of the detected audio data is converted into the reference sampling frequency with the corresponding the conversion part.

3. An audio mixing device according to claim 1, wherein the control part comprises:
a detecting part configured to detect audio data in which the sampling frequency is changed among all audio data input to the plurality of input parts;
a calculation part configured to calculate a conversion rate for converting the sampling frequency of the audio data detected in the detecting part into the reference sampling frequency; and
a setting part configured to set the conversion rate calculated with the calculation part to the conversion part corresponding to the audio data detected in the detecting part, and to convert the sampling frequency of the audio data input to the conversion part into the reference frequency.

4. An audio mixing device according to claim 1, wherein the control part detects the audio data in which the sampling frequency is changed and controls so that the output of the audio data is stopped while the sampling frequency of the detected audio data is converted into the reference sampling frequency with the corresponding the conversion part.

5. An audio mixing device according to claim 1, wherein the control part comprises:
a detecting part configured to detect audio data in which the sampling frequency is changed among all audio data input to the plurality of input parts;
a stopping part configured to stop the output from the conversion part corresponding to the audio data detected in the detecting part; and
an outputting part configured to output the audio data after the sampling frequency of the audio data detected in the detecting part is converted into the reference sampling frequency with the corresponding the conversion part.

6. An audio mixing device according to claim 1, wherein the control part, via some operation, can selectively set the reference frequency to be used from among a plurality of prepared reference sampling frequencies.

7. An audio mixing device according to claim 1, wherein the audio data obtained from a disk or a network server is input to the plurality of input parts.

8. An audio mixing method comprising:
a first process for inputting a plurality of audio data digitized respectively;
a second process for converting the sampling frequencies of all audio data input in the first process into the preset reference sampling frequency; and
a third process for mixing all audio data in which the sampling frequency is converted into the reference sampling frequency during the second process.

9. An audio mixing method according to claim 8, wherein the second process detects the audio data in which the sampling frequency is changed and converts the detected sampling frequency of the audio data into the reference sampling frequency.

10. An audio mixing method according to claim 8, wherein the second process comprises:
a process for detecting the audio data in which the sampling frequency is changed among the plurality of audio data;
a process for calculating the conversion rate for converting the sampling frequency of the detected audio data into the reference sampling frequency; and
a process for converting the sampling frequency of the detected audio data into the reference sampling frequency based on the calculated conversion rate.

11. An audio mixing method according to claim 8, wherein the second process detects the audio data in which the sampling frequency is changed and stops the output of the audio data while the sampling frequency of the detected audio data is converted into the reference sampling frequency.

12. An audio mixing method according to claim 8, wherein the second process comprises:
a process for detecting the audio data in which the sampling frequency is changed among the plurality of audio data;
a process for stopping the output of the detected audio data;
a process for converting the sampling frequency of the detected audio data into the reference sampling frequency; and
a process for outputting the audio data converted into the reference sampling frequency.

13. An audio mixing method according to claim 8, wherein the second process, via some operation, can selectively set the reference frequency to be used from among a plurality of prepared reference sampling frequencies.
